(19) United States
(12) Patent Application Publication
(10) Pub. No.: US 2016/0034185 A1
(43) Pub. Date: Feb. 4, 2016

(54) HOST-BASED DEVICE DRIVER SPLITTING OF INPUT/OUT FOR REDUNDANT ARRAY OF INDEPENDENT DISKS SYSTEMS

(71) Applicant: LSI Corporation, San Jose, CA (US)

(72) Inventors: Horia Simionescu, Milpitas, CA (US); Kunal Sablok, Bangalore (IN); Siddharth Kumar Panda, Bangalore (IN); Durga Prasad Bhattarai, Bangalore (IN)

(21) Appl. No.: 14/447,344

(22) Filed: Jul. 30, 2014

(51) Int. Cl. G06F 3/06

(52) U.S. Cl. CPC G06F 3/061; G06F 3/0647; G06F 3/0689

(57) ABSTRACT

Methods and structure for splitting Input/Output (I/O) for Redundant Array of Independent Disks (RAID) systems. One embodiment is a system that includes a processor of a host, and a memory of the host. The processor and the memory implement a device driver for communicating with a physically distinct RAID controller. The device driver is able to receive an I/O request, from an Operating System of the host, that is directed to a RAID volume. The device driver is further able to determine that the controller includes dedicated circuitry for handling I/O requests directed to a single RAID strip. Responsive to determining that the controller includes such dedicated circuitry, the device driver is able to identify RAID strip boundaries within the received request, and to generate multiple child I/O requests that are each directed to a single strip of the volume and correspond to the identified strip boundaries.

### FIELD OF THE INVENTION

The invention relates generally to Redundant Array of Independent Disks (RAID) systems.

### BACKGROUND

In a RAID environment, a host Operating System (OS) provides Input/Output (I/O) requests to a RAID controller. The I/O requests indicate that data should be written to, or read from, one or more Logical Block Addresses (LBAs) of a logical volume. The RAID controller processes incoming I/O requests to correlate the requested LBAs with physical addresses on one or more storage devices that store data for the volume. The RAID controller can then split an I/O request into individual requests that are each directed to a corresponding storage device in order to retrieve/store the data at the physical addresses.

### SUMMARY

Systems and methods herein provide host device drivers that are capable of generating child I/O requests based on the strip boundaries of received I/O requests, and providing the child I/O requests to a RAID controller for expedited processing.

One embodiment is a system that includes a processor of a host, and a memory of the host. The processor and the memory implement a device driver for communicating with a physically distinct RAID controller. The device driver is able to receive an I/O request, from an Operating System of the host, that is directed to a RAID volume. The device driver is further able to determine that the controller includes dedicated circuitry for handling I/O requests directed to a single RAID strip. Responsive to determining that the controller includes such dedicated circuitry, the device driver is able to identify RAID strip boundaries within the received request, and to generate multiple child I/O requests that are each directed to a single strip of the volume and correspond to the identified strip boundaries.

Other exemplary embodiments (e.g., methods and computer readable media relating to the foregoing embodiments) are also described below.

### BRIEF DESCRIPTION OF THE FIGURES

Some embodiments of the present invention are now described, by way of example only, and with reference to the accompanying figures. The same reference number represents the same element or the same type of element on all figures.

FIG. 1 is a block diagram of an exemplary RAID storage system.

FIG. 2 is a block diagram illustrating exemplary striping in a RAID environment.

FIG. 3 is a flowchart describing an exemplary method to operate a host-side device driver for a RAID controller to split I/O requests from an OS.

FIG. 4 is a block diagram illustrating exemplary splitting of I/O requests in a RAID environment.

FIG. 5 is a block diagram of an exemplary RAID controller that includes dedicated circuitry for handling single strip I/O requests.

FIG. 6 is a flowchart describing an exemplary method for selectively splitting I/O requests from an OS.

FIG. 7 illustrates an exemplary processing system operable to execute programmed instructions embodied on a computer readable medium.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

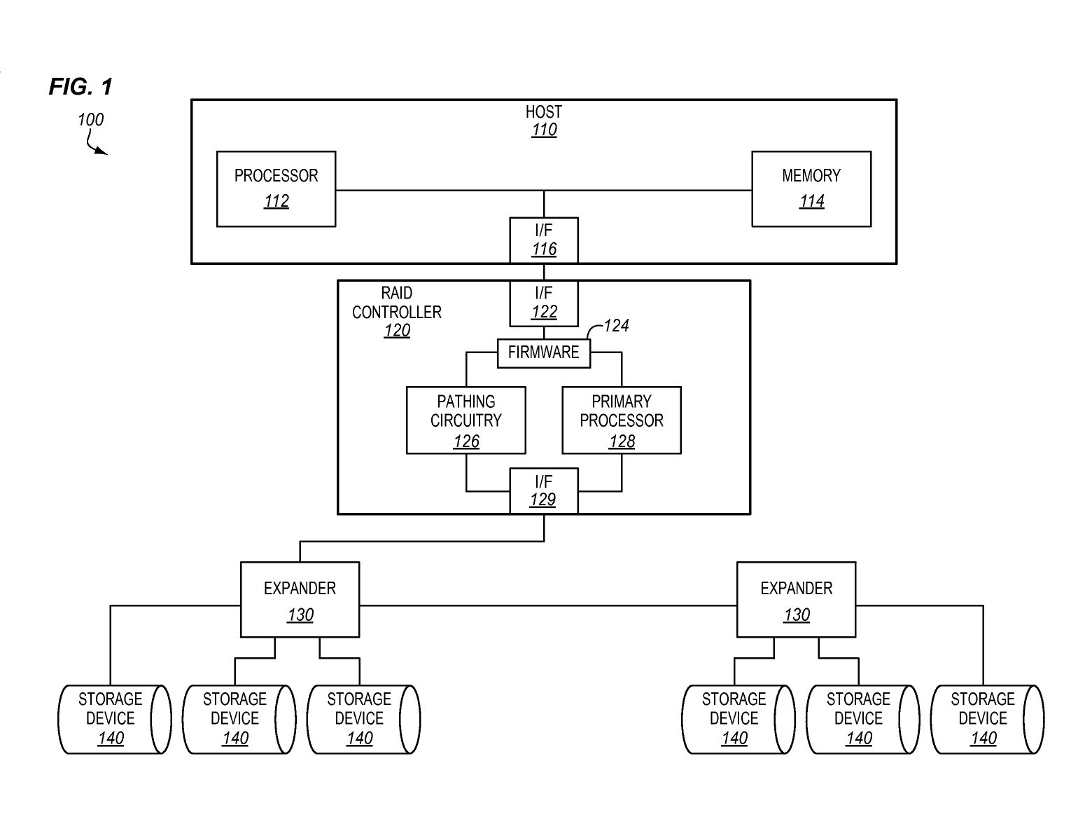

FIG. 1 is a block diagram of an exemplary RAID storage system 100. According to FIG. 1, RAID storage system 100 includes host system 110, RAID controller 120, and a switched fabric comprising multiple expanders 130 and storage devices 140. The switched fabric includes any suitable combination of communication channels operable to forward/route communications according to protocols for one or more of Small Computer System Interface (SCSI), Serial Attached SCSI (SAS), Fibre Channel, Ethernet, Internet SCSI (ISCSI), etc. In this embodiment, an OS of host 110 generates I/O requests that are directed to LBAs of a RAID volume managed by RAID controller 120. The I/O requests are sent to RAID controller 120, which correlates the requested LBAs with physical addresses at one or more storage devices 140. Since RAID volumes stripe individual LBAs across multiple storage devices in order to enhance redundancy and/or disk access speed, I/O requests received at RAID controller 120 generally cannot be translated into a single command for a single storage device 140 of the switched fabric. This is why RAID controller 120 engages in a processing intensive technique to generate multiple storage device-specific I/O requests based on each multi-strip I/O request received from host 110.

A RAID controller can become overloaded when tasked with generating child I/O requests for a large number of I/O requests from the host. To address this problem, host 110 includes processor 112 and memory 114, which implement a device driver for communicating with RAID controller 120. The device driver is capable of splitting received I/O requests from the OS along their strip boundaries in order to generate child I/O requests. The child I/O requests, because they have already been split along their strip boundaries, can be more easily processed by RAID controller 120, which in turn reduces I/O congestion at RAID controller 120. Specifically, in one embodiment, the device driver is RAID-aware, and has complete knowledge of mapping between a RAID volume and its corresponding physical devices. The device driver in is therefore capable of determining how many strips of a RAID volume an I/O request will impact. The device driver can further direct the I/O requests to specific processors in the RAID controller as desired.

Host 110 comprises any system capable of performing processing operations upon stored data. Host I/O requests directed to a logical volume include requests to retrieve data from the logical volume as well as requests to modify written data at the logical volume. In this embodiment, processor 112 and memory 114 (e.g., Random Access Memory (RAM), a Solid State Drive (SSD), hard disk, etc.) of host 110 comprise hardware elements that perform stored instructions in order to operate an OS, and also to operate a device driver for communicating with RAID controller 120. In further embodiments, the device driver implemented at host 110 can be implemented as custom circuitry, a processor executing programmed instructions stored in program memory, or some combination thereof

The OS implements file systems and/or interfaces for performing computing tasks as desired. The device driver manages communications with RAID controller 120. Meanwhile, interface (I/F) 116 (e.g., a Peripheral Component Interconnect (PCI) interface), transfers data (e.g., I/O requests and completions) between host 110 and RAID controller 120.

RAID controller 120 is physically distinct from host 110 (e.g., as a separable/detachable component coupled with host 110), and comprises any component/devices operable to manage a RAID volume in order to store and/or retrieve data on behalf of host 110. For example, in one embodiment, RAID controller 120 comprises a Host Bus Adapter (HBA) inserted into a motherboard of host 110. RAID controller 120 includes I/F 122, which is compatible with the protocols supported by I/F 116. For example, in one embodiment, I/F 122 and I/F 116 comprise PCI Express (PCIe) interfaces that share a common bus.

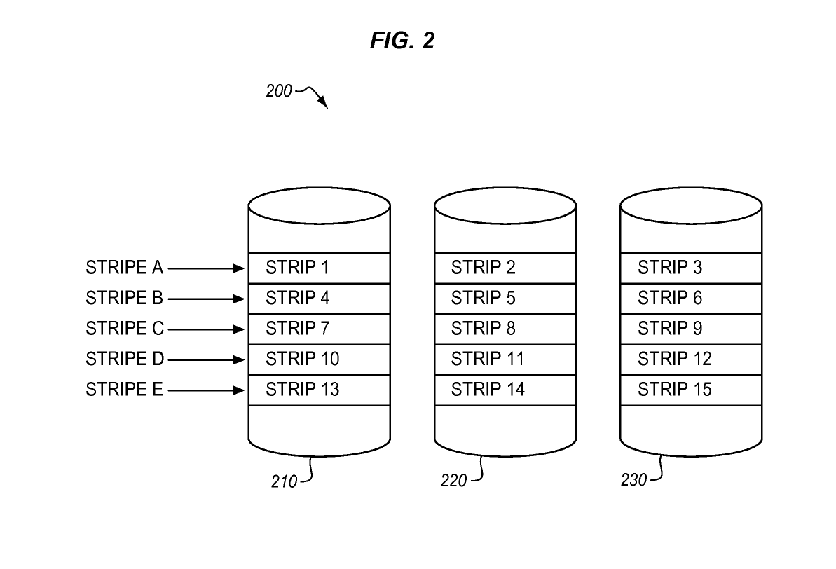

In this embodiment, RAID controller 120 includes pathing circuitry 126, and primary processor 128. Primary processor 128 manages the processing of multi-strip write requests, while pathing circuitry 126 manages the processing of single-strip write requests. Consider block diagram 200 of FIG. 2, which illustrates strip boundaries in a RAID volume that includes three storage devices (210, 220, and 230). In a RAID volume, groups of LBAs can be “striped” across multiple storage devices, which increases the speed at which the LBAs can be accessed. A “stripe” represents a set of one or more LBAs written across multiple disks, along with any corresponding parity or redundancy information. Meanwhile, a “strip” is a portion of a stripe that has been written to a single storage device. Thus, only one I/O request is sent to one storage device in order to acquire a strip of data, while multiple I/O requests are sent to multiple storage devices in order to retrieve an entire stripe.

Returning to FIG. 1, pathing circuitry 126 is dedicated to handling single-strip I/O requests from host 110 (i.e., I/O requests that are directed to a single strip of data), while primary processor 128 is dedicated to splitting multi-strip I/O requests. Since the processing overhead for handling a multi-strip I/O request is significant, primary processor 128 can experience delays when under heavy I/O load. Because of these differences in processing overhead, it is not uncommon for pathing circuitry 126 to be idle while primary processor 128 is experiencing delays. This can result in significant latency problems, causing poor overall performance of the storage system. Pathing circuitry 126 can be implemented as dedicated circuitry, such as a hardware processor compliant with LSI Corporation standards for FastPath processing.

RAID controller 120 further includes firmware 124. Firmware 124 determines whether incoming I/O requests are single strip or multi-strip requests, and routes these incoming I/O requests to a specific processor of RAID controller 120 based on directive information provided by the device driver. Firmware 124 can be implemented as circuitry, a processor implementing stored instructions, etc. RAID controller 120 also includes I/F 129. I/F 129 allows RAID controller to generate commands in a protocol supported by the switched fabric and/or storage devices 140. In one embodiment, I/F 129 comprises a SAS physical link (PHY) capable of processing and generating SAS commands for accessing storage devices 140.

Storage devices 140 implement storage space for one or more logical volumes. A logical volume can be implemented on any number of storage devices 140 as a matter of design choice. Furthermore, storage devices 140 need not be dedicated to only one logical volume, but can also store data for a number of other logical volumes.

The particular arrangement, number, and configuration of components described herein is exemplary and non-limiting. While in operation, RAID storage system 100 utilizes the device driver of host 110 in order to preemptively split I/O requests from the OS at their strip boundaries, thereby saving processing time and resources at RAID controller 120. This is particularly beneficial in embodiments where host 110 has greater processing capabilities than RAID controller 120. For example, many hosts utilize a powerful processor and include large amount of main memory.

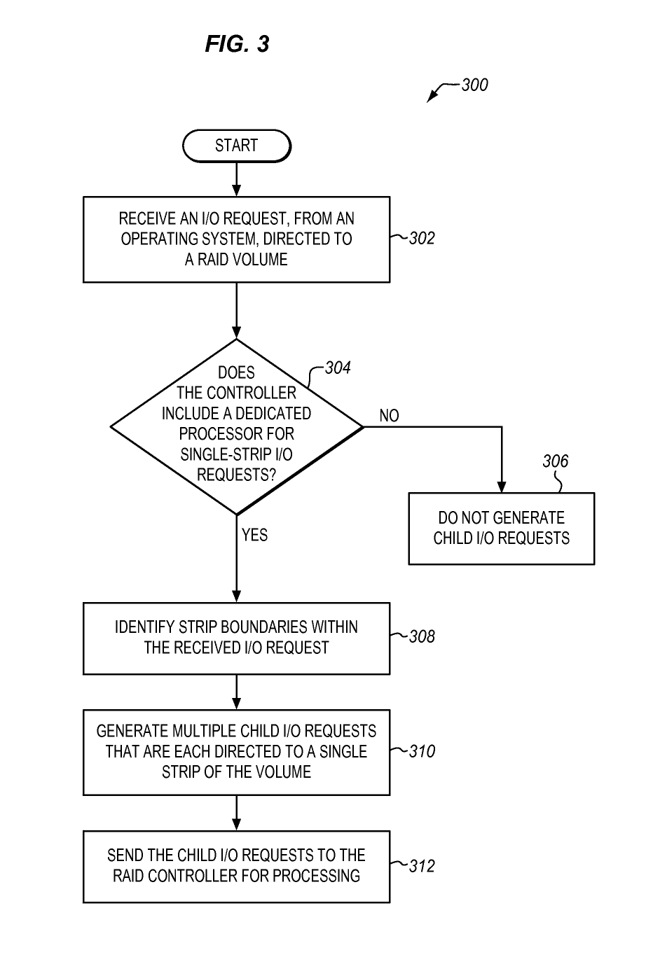

FIG. 3 is a flowchart describing an exemplary method 300 to operate a host-side device driver for a RAID controller to split I/O requests from an OS. Assume, for this embodiment, that a RAID volume has been initialized by RAID controller 120, and that host 110 and RAID controller 120 cooperate in order to retrieve and/or alter data for the volume as maintained on multiple storage devices 140. Specifically, an OS of host 110 generates a series of I/O requests directed to LBAs of the RAID volume.

In step 302, the device driver of host 110 receives an I/O request from the OS. In one embodiment, the I/O request from the OS includes a Command Descriptor Block (CDB) as well as a Scatter Gather List (SGL) directed to a logical volume managed by RAID controller 120. The CDB indicates the starting LBA of the request, and the length of the request. Meanwhile, the SGL specifically indicates physical pages in host memory that include data to be written to the storage volume, or physical pages where data is to be read from the storage volume. The CDB and SGLs completely describe the IO request.

In step 304, the device driver performs a check to determine whether RAID controller 120 includes dedicated circuitry for single-strip I/O requests. If RAID controller 120 did not include dedicated circuitry for single-strip requests, then there would be little performance benefit to be had by splitting I/O requests at the host-side. In fact, since many RAID controllers are only capable of handling a certain number of requests at a time, splitting I/O requests from the OS can potentially be inefficient because it can quickly fill up the processing queue of the RAID controller. To this end, if RAID controller 120 did not include pathing circuitry 126, the device driver of host 110 would refrain from generating child I/O requests based upon the received host request in step 306, and would forward the host request in an unaltered state to RAID controller 120.

In this embodiment, RAID controller 120 includes pathing circuitry 126, which is dedicated to processing single-strip I/O requests. This means that single-strip I/O requests can be processed quickly and efficiently at RAID controller 120 without congesting I/O traffic. Thus, processing continues to step 308. While step 304 is described as being responsive to receiving an I/O request from the OS, in further embodiments this step can be performed upon the initial connection of host 110, to RAID controller 120, during boot for host 110, upon creation of a RAID volume managed by RAID controller 120, etc.

In step 308, the device driver of host 110 identifies strip boundaries within the received I/O request. As used herein, a strip boundary refers to the bounds of a contiguous set of physical addresses that are maintained on a single storage device 140 and form a portion of a RAID stripe. An I/O request can be directed to multiple stripes of volume data, and each stripe is composed of strips that each pertain to a single storage device 140. Thus, an I/O request from a host directed to one or more stripes of data can be decomposed, based on the range of LBAs, into one or more child I/O requests that are each directed to a single strip of a different storage device 140.

In step 310, the device driver of host 110 generates multiple child I/O requests that are each directed to a single strip of the RAID volume. This means that each of the child requests can be handled by pathing circuitry 126 instead of primary processor 128. In one embodiment, as part of the creation of the child I/O requests, the device driver correlates requested LBAs found in the I/O request from the OS with physical addresses on one or more storage devices 140. The device driver then generates a child I/O request for each requested strip from the original I/O request. In a further embodiment, each child I/O request includes its own CDB and SGL, which are each based on the CDB and SGL of the I/O request received from the OS. The originally received I/O request from the OS can be retained within the device driver as it waits for the child I/O requests to complete, or can be discarded (i.e., without transmitting the I/O request to RAID controller 120) or ignored as desired. Alternatively, if the originally received I/O request is already directed to a single strip of the RAID volume, then the device driver forwards the request, as received, to RAID controller 120 for processing.

RAID controller 120 receives the child I/O requests as they were transmitted by the device driver across I/F 116 to I/F 122 in step 312. Since RAID controller 120 implements technology in the form of dedicated circuitry for handling these requests (e.g., a version of LSI Corporation FastPath technology), RAID controller 120 rapidly handles the child I/O requests at pathing circuitry 126. This in turn free up resources that would otherwise be consumed by primary processor 128. Since in many embodiments primary processor 128 is responsible for reporting I/O completions, performing error handling, processing multi-strip I/O requests, etc., this technique can substantially increase the overall speed of I/O processing at RAID controller 120. This is true even though processing resources at the host are used to facilitate RAID processes.

Even though the steps of method 300 are described with reference to RAID storage system 100 of FIG. 1, method 300 can be performed in other RAID systems and configurations. The steps of the flowcharts described herein are not all inclusive and can include other steps not shown. The steps described herein can also be performed in an alternative order.

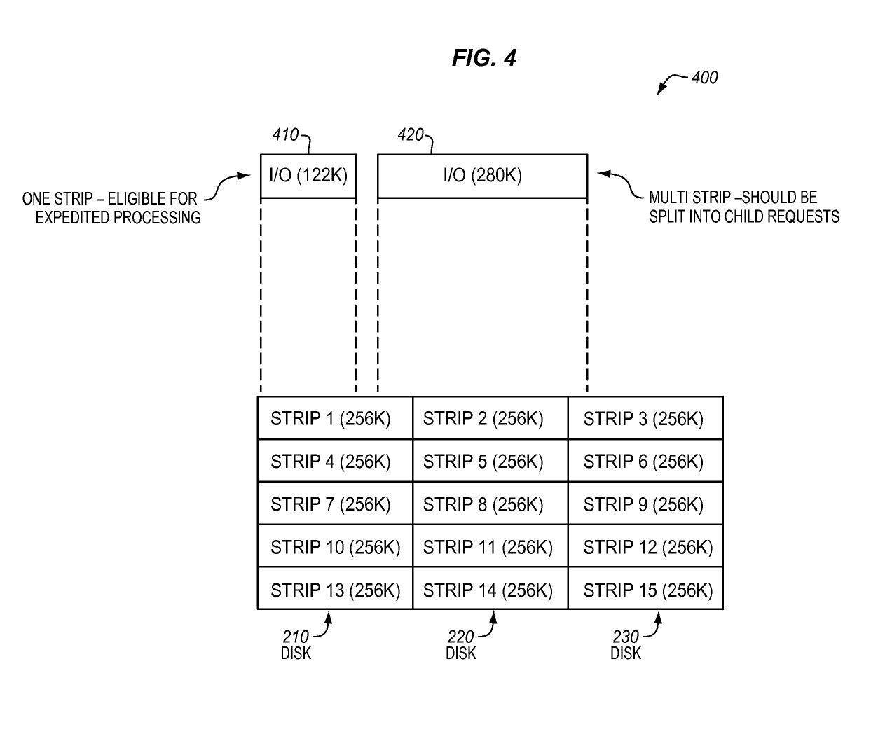

FIG. 4 is a block diagram 400 illustrating exemplary splitting of I/O requests in a RAID environment. According to FIG. 4, a logical RAID volume is maintained on three separate physical disks (310, 320, and 330). Two incoming I/O requests (410, 420) are received for processing. The first request 410 is directed to 122 Kb of data within a single strip of data. Therefore, request 410 is forwarded by the device driver to RAID controller 120 as-is. However, request 420 is directed to 280 Kb of data, which is spread across three different strips. The device driver of host 110 therefore splits request 420 into three individual requests that are each directed to a single strip (i.e., strips 1, 2, and 3). These single-strip I/O requests qualify for expedited processing via pathing circuitry 126, which enhances the overall I/O throughput of RAID controller 120.

In a further embodiment, the device driver of host 110 periodically acquires RAID mapping information from RAID controller 120. This RAID mapping information correlates LBAs of the file system used by the OS with physical addresses on individual storage devices 140. In this manner, the device driver can split incoming I/O requests without error even when the configuration of the RAID volume changes. RAID controller 120 can push (or the device driver can pull) updated mapping information on a regular, periodic basis (e.g., once every period of time), or whenever an event occurs that changes the way that the RAID volume is mapped (e.g., whenever the RAID volume is migrated, etc.).

In a still further embodiment, the device driver is capable of receiving I/O completions from RAID controller 120 that pertain to each of the child I/O requests. Upon receiving an I/O completion for each child I/O request generated from the originally received I/O request, the device driver reports successful completion of the originally received I/O request to the OS. In this manner, the OS remains unaware that the original I/O request has been split. If any of the child I/O requests is completed with an error, then the device driver reports an error for the originally received I/O to the OS. In this embodiment, partial completion of split I/O requests can be avoided, since the OS is not aware of the I/O splitting performed by the device driver.

### EXAMPLES

In the following examples, additional processes, systems, and methods are described in the context of a device driver, implemented by a processor and a memory of the host, that communicates with a RAID controller in order to handle I/O requests for an OS.

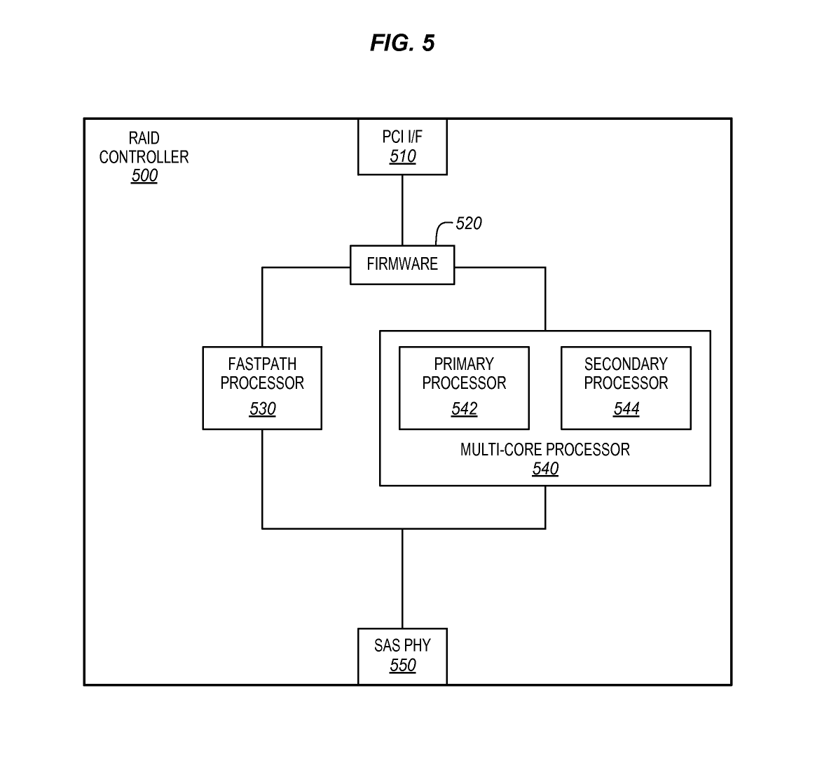

In this example, the device driver communicates with RAID controller 500 of FIG. 5 via a PCI bus. RAID controller 500 includes its own PCI I/F 510, as well as firmware 520. Firmware 520 comprises circuitry capable of receiving I/O requests via PCI I/F 510, and routing the I/O requests to specific processors of RAID controller 500 based on directive information provided by a device driver. Firmware 520 forwards single strip requests to FastPath processor 530, and forwards multi-strip requests to multi-core processor 540. Multi-core processor 540 includes primary processor 542, and secondary processor 544. Primary processor 544 handles multi-strip read requests, reports I/O completion statuses to host 110, and performs error handling. Meanwhile, secondary processor 544 performs processing of write requests. When primary processor 542 and secondary processor 544 process multi-strip I/O requests, they utilize stored RAID mapping information to translate these requests into multiple individual SAS commands directed across SAS PHY 550 to individual storage devices. In contrast to primary processor 542 and secondary processor 544,

FastPath processor 530 includes logical instructions for rapidly handling single strip I/O requests. For example, in one embodiment FastPath processor 530 pulls I/O requests directly from host memory via DMA (Direct Memory Access), and sends the I/O requests to physical storage devices without involving any processing in the RAID firmware. This means that multi-core processor 540 of RAID controller 500 does not waste memory and processing cycles in handling FastPath requests. Since the physical addresses for the child I/O requests are computed by a device driver, Fastpath processor 530 can directly translate child I/O requests into a SCSI request for a specific protocol (SAS/SATA) with minimal computational effort. Therefore, FastPath processor 530 can quickly and effectively handle single-strip I/O requests in order to generate SAS commands and reduce the workload at multi-core processor 540.

In this example, RAID controller 500 implements a queuing system based on System Message IDs (SMIDs). Each SMID corresponds to a memory buffer available at RAID controller 500, and each incoming I/O request from host 110 is provided with a SMID if one is available. When an I/O request receives a SMID, the device driver of host 110 writes descriptors for the I/O request into a corresponding buffer of RAID controller 500 so that the I/O request will be processed. In this example, RAID controller 500 implements 1024 SMIDs that each correspond to a unique buffer. Furthermore, in this example the device driver of host 110 is capable of selectively engaging in I/O splitting processes, in order to ensure that hostside I/O splitting does not over-utilize the number SMIDS at RAID controller 500.

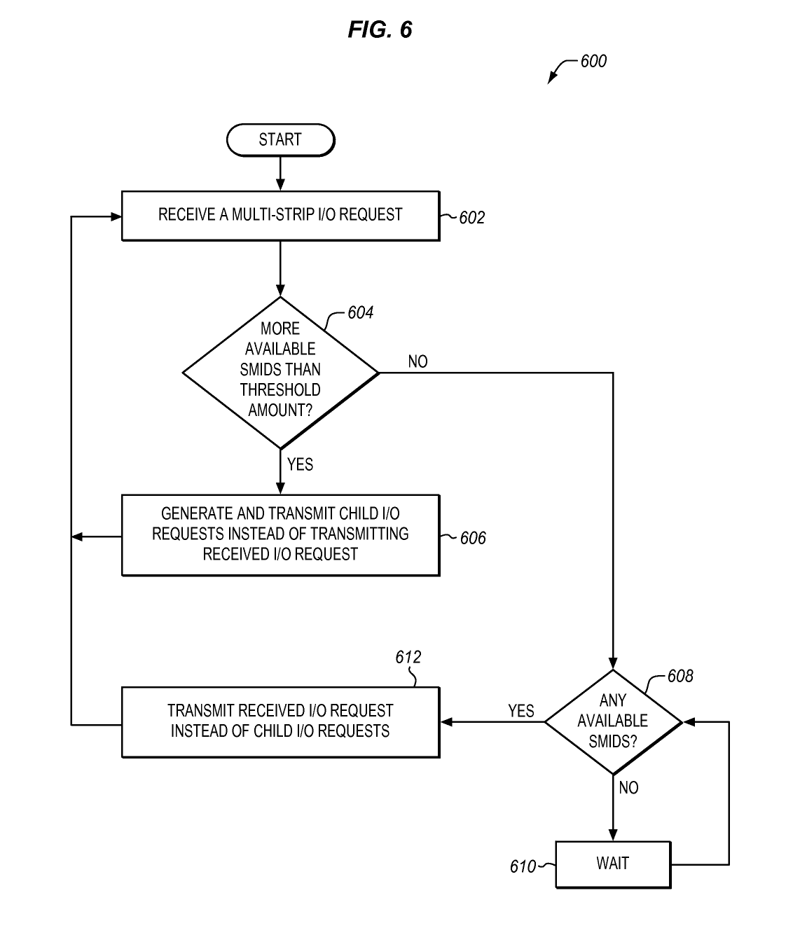

FIG. 6 is a flowchart describing an exemplary method 600 for selectively splitting I/O requests from an OS. According to method 600, the device driver of host 110 receives a multi-strip I/O request from the OS in step 602, and then decides whether or not to split the multi-strip I/O request into single-strip child I/O requests. To this end, in step 604 the device driver determines a number of available SMIDs at RAID controller 500, and compares this number of available SMIDs against a threshold amount (e.g., a percentage of the total number of SMIDs, a specific number, etc.). Determining the number of available SMIDs can be accomplished by the device driver tracking the number of I/O requests sent to RAID controller 500, and the number of I/O completions received from RAID controller 500.

If there are more available SMIDs than the threshold amount (in this case, if more than two thirds of the total number of SMIDs are available), then the device driver generates the child I/O requests in step 606 and transmits them to RAID controller 500 for processing. Alternatively, if there are fewer available SMIDs than the threshold amount, processing continues to step 608 where the device driver determines if any SMIDs at all are available at RAID controller 500. If no SMIDs are available, the device driver waits in step 610 for a SMID to become available. If at least one SMID becomes available, then processing continues to step 612, wherein the originally received I/O request from the OS is sent to RAID controller 500, without modification. Selectively refraining from generating child I/O requests in this manner ensures that child I/O requests will not overcrowd or otherwise impact the SMID-based processing of RAID controller 500.

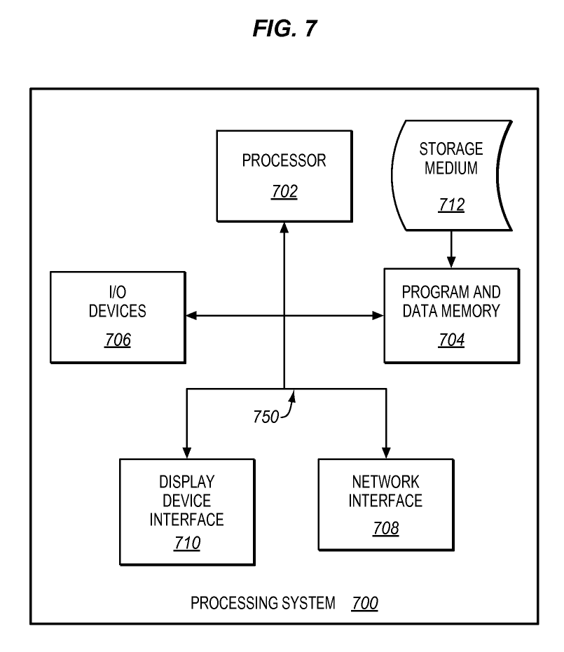

Embodiments disclosed herein can take the form of software, hardware, firmware, or various combinations thereof In one particular embodiment, software is used to direct a processing system of RAID storage system 100 to perform the various operations disclosed herein. FIG. 7 illustrates an exemplary processing system 700 operable to execute a computer readable medium embodying programmed instructions. Processing system 700 is operable to perform the above operations by executing programmed instructions tangibly embodied on computer readable storage medium 712. In this regard, embodiments of the invention can take the form of a computer program accessible via computer readable medium 712 providing program code for use by a computer (e.g., processing system 700) or any other instruction execution system. For the purposes of this description, computer readable storage medium 712 can be anything that can contain or store the program for use by the computer (e.g., processing system 700).

Computer readable storage medium 712 can be an electronic, magnetic, optical, electromagnetic, infrared, or semiconductor device. Examples of computer readable storage medium 712 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 700, being suitable for storing and/or executing the program code, includes at least one processor 702 coupled to program and data memory 704 through a system bus 750. Program and data memory 704 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 706 (including but not limited to keyboards, displays, pointing devices, etc.) can be coupled either directly or through intervening I/O controllers. Network adapter interfaces 708 can also be integrated with the system to enable processing system 700 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 710 can be integrated with the system to interface to one or more display devices, such as printing systems and screens for presentation of data generated by processor 702.

What is claimed is:

1. A system, comprising:
a processor of a host; and
a memory of the host,
wherein the processor and the memory of the host implement a device driver for communicating with a physically distinct Redundant Array of Independent Disks (RAID) controller,
wherein the device driver is operable to receive an Input/Output (I/O) request, from an Operating System of the host, that is directed to a RAID volume,
wherein the device driver is further operable to determine that the controller includes dedicated circuitry for handling I/O requests directed to a single RAID strip, and
wherein the device driver is further operable, responsive to determining that the controller includes such dedicated circuitry, to identify RAID strip boundaries within the received request, and to generate multiple child I/O requests that are each directed to a single strip of the volume and correspond to the identified strip boundaries.

2. The system of claim 1, wherein:
the device driver is further operable to selectively determine whether to generate the child I/O requests, based on a number of Single Message Identifiers (SMIDs) available at the controller.

3. The system of claim 2, wherein:
the device driver is further operable to generate the child requests if more than a threshold amount of SMIDs are available at the controller.

4. The system of claim 1, wherein:
the received request comprises a Command Descriptor Block (CDB) and a Scatter Gather List (SGL), and
each child request includes a unique CDB and SGL based on the CDB and SGL of the received request.

5. The system of claim 1, wherein:
the device driver is further operable to transmit the child requests, instead of the received request, to the controller.

6. The system of claim 1, wherein:
the device driver is further operable to maintain a copy of RAID mapping information for the volume by communicating with the controller, and to identify the strip boundaries based on the RAID mapping information.

7. The system of claim 1, wherein:
the device driver is further operable to direct a Peripheral Component Interconnect (PCI) interface to transmit the child requests to the controller.

8. The system of claim 1, wherein:
the device driver is further operable to complete the received request without transmitting it to the controller.

9. A method comprising:
receiving, at a device driver of a host for communicating with a physically distinct Redundant Array of Independent Disks (RAID) controller, an Input/Output (I/O) request that is directed to a RAID volume;
determining, at the device driver, that the controller includes dedicated circuitry for handling I/O requests directed to a single RAID strip; and
responsive to determining that the controller includes such dedicated circuitry:
identifying strip boundaries within the received request; and
generating multiple child I/O requests that are each directed to a single strip of the volume and correspond to the identified strip boundaries.

10. The method of claim 9, further comprising:
selectively determining whether to generate the child I/O requests, based on a number of Single Message Identifiers (SMIDs) available at the controller.

11. The method of claim 10, further comprising:
generating the child requests if more than a threshold amount of SMIDs are available at the controller.

12. The method of claim 9, wherein:
the received request comprises a Command Descriptor Block (CDB) and a Scatter Gather List (SGL), and
each child request includes a unique CDB and SGL based on the CDB and SGL of the received request.

13. The method of claim 9, further comprising:
transmitting the child requests, instead of the received request, to the controller.

14. The method of claim 9, further comprising:
maintaining a copy of RAID mapping information for the volume by communicating with the controller; and
identifying the strip boundaries based on the RAID mapping information.

15. The method of claim 9, further comprising:
directing a Peripheral Component Interconnect (PCI) interface to transmit the child requests to the controller.

16. The method of claim 9, further comprising:
performing the method without transmitting the received request to the controller.

17. A system comprising:
host-side means for communicating with a physically distinct Redundant Array of Independent Disks (RAID) controller,
wherein the means is for receiving an Input/Output (I/O) request, from an Operating System of the host, that is directed to a RAID volume,
wherein the means is further for determining that the controller includes dedicated circuitry for handling I/O requests directed to a single RAID strip, and
wherein the means is further for, responsive to determining that the controller includes such dedicated circuitry, identifying RAID strip boundaries within the received request, and generating multiple child I/O requests that are each directed to a single strip of the volume and correspond to the identified strip boundaries.

18. The system of claim 17, wherein:
the means is further for selectively determining whether to generate the child I/O requests, based on a number of Single Message Identifiers (SMIDs) available at the controller.

19. The system of claim 18, wherein:
the means is further for generating the child requests if more than a threshold amount of SMIDs are available at the controller.

20. The system of claim 17, wherein:
the received request comprises a Command Descriptor Block (CDB) and a Scatter Gather List (SGL), and
each child request includes a unique CDB and SGL based on the CDB and SGL of the received request.
